(19) United States
(12) Patent Application Publication
(10) Pub. No.: US 2009/0328189 A1
(43) Pub. Date: Dec. 31, 2009

(54) SECURE WIRELESS COMMUNICATION INITIALIZATION SYSTEM AND METHOD

(75) Inventors: Alan T. BUDYTA, Grand Blanc, MI (US); Ansaf I. ALRABADY, Livonia, MI (US); Michael J. ABOWD, Ann Arbor, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/115,372

(22) Filed: May 5, 2008

(51) Int. Cl. G06F 21/00; H04L 12/28; H04B 7/00

(52) U.S. Cl. 726/14; 370/254; 370/310

(57) ABSTRACT

A wireless communication system for use with a vehicle is disclosed. The communication system comprises a portable wireless device comprising a first manual interface device, the portable wireless device adapted to transmit an activation signal in response to manipulation of the first manual interface device, and an onboard wireless communication device for a vehicle. The onboard wireless communication device can be adapted to transmit Wi-Fi Protected Setup initiation signals in response to receiving the activation signal.

### TECHNICAL FIELD

Embodiments of the subject matter described herein relate generally to secure wireless communication. More particularly, embodiments of the subject matter relate to initializing communication between components of a wireless system to permit secure communications therebetween.

### BACKGROUND

Vehicles, including automobiles, are being configured to interface with remote computing systems to a greater degree. For example, some vehicles are configurable to store digital audio content, such as music or audio books, for later playback. Other vehicles can allow certain parameters, including preferences such as displayed units of measurement or positioning settings for seats in the vehicle, to be transmitted to, and stored in, a remote computer system. In some cases the parameters can be selected in the remote computer system and transferred to the vehicle for use.

To interface with remote computer systems, a network connection is usually established between the vehicle and the computer. Preferably, such a connection is established using a wireless network adapter, removing the need for a physical coupling between the vehicle and some portion of a network infrastructure.

Because transmission of information through a wireless network requires broadcast of the information, the possibility of unwanted observation of the transmitted information is an inherent risk in any wireless network. To mitigate and minimize such risk, communication over a wireless network can be encrypted, significantly reducing the likelihood an observer can decipher and understand the information being passed between systems communicating over the network. Additionally, such encryption can make it difficult for a third party to participate in the network, despite being able to broadcast information conforming to the network protocol.

To establish encryption between two participants in a wireless network, some initialization information is usually exchanged between them, such as key information. With exchanged key information, participants in a wireless network can communicate through an encrypted channel. Securely exchanging key information between participants in a wireless network can be cumbersome to do simply.

### BRIEF SUMMARY

An apparatus is provided for a wireless communication system. The wireless communication system can comprise a portable wireless device comprising a first manual interface device, the portable wireless device adapted to transmit an activation signal in response to manipulation of the first manual interface device, and an onboard wireless communication device for a vehicle, the onboard wireless communication device adapted to transmit Wi-Fi Protected Setup (WPS) initiation signals in response to receiving the activation signal.

A method of setting up security credentials for establishing secure communication between a vehicle and a wireless access point is also disclosed. The method can comprise receiving a wireless activation signal from a key fob associated with the vehicle, and transmitting a Wi-Fi Protected Setup (WPS) initiation signal from the vehicle in response to reception by the vehicle of the wireless activation signal.

Another method of establishing secure communication between a vehicle and a wireless access point is disclosed. The method can comprise receiving a wireless network security protocol initiation signal at the vehicle, transmitting a notification signal from the vehicle in response to receiving the wireless network security protocol initiation signal, receiving the notification signal at a key fob, operating a feedback device of the key fob in response to the notification signal, transmitting an acknowledgement signal from the key fob in response to manipulation of a manual interface device of the key fob, receiving the acknowledgement signal at the vehicle, and transmitting a wireless network security protocol response signal from the vehicle in response to receiving the acknowledgment signal.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic illustration of an embodiment of a secure wireless communication system and method of operation;

FIG. 2 is a schematic illustration of another embodiment of a secure wireless communication system and method of operation;

FIG. 3 is a diagram that illustrates communication of wireless signals for an embodiment of a secure wireless communication system; and

FIG. 4 is a diagram that illustrates communication of wireless signals for another embodiment of a secure wireless communication system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a control system or computing system or any component thereof may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The computer data signal may include any signal that can propagate over a transmission medium such as electronic network channels, optical fibers, air, electromagnetic paths, or RF links, including wireless networks conforming to certain Institute of Electrical and Electronics Engineers (IEEE), among others.

“Node/Port”—As used herein, a “node” means any internal or external reference point, connection point, junction, signal line, conductive element, or the like. Furthermore, two or more nodes may be realized by one physical element (and two or more signals can be multiplexed, modulated, or otherwise distinguished even though received or output at a common mode). “Node” can also refer to a member of a wireless network, such as an access point, or computer system communicating with other members of the wireless network with a wireless adapted and/or transceiver. When used in the context of a wireless network, a participant in a wireless network can be a node in the wireless network.

“Connected/Coupled”—The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one exemplary arrangement of elements, additional intervening elements, devices, features, or components may be present in an embodiment of the depicted subject matter.

The terms “first”, “second” and other such numerical terms referring to structures do not imply a sequence or order unless clearly indicated by the context.

For the sake of brevity, conventional techniques related to signal processing, data transmission, signaling, network control, network setup, encryption, including public key encryption, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

FIG. 1 illustrates a wireless communication system 1 comprising, among other possible elements, a key fob 10, a vehicle 40, and a wireless access point 70. Typically, the key fob 10 can be operated by a user to control various features of the vehicle 40, such as unlocking doors, unlatching the trunk, or changing the operational state of a theft deterrent system. The vehicle 40 can be adapted to wirelessly communicate with the wireless access point 70 to enable an exchange of communication of the sort, and for the purpose, described above.

The key fob 10 preferably comprises a first wireless transceiver 12, a first control system 14, a first manual interface device 16, a second manual interface device 18, and a first feedback device 20. The first wireless transceiver 12 can be coupled to the first control system 14. The first control system 14 can be coupled to the first and second manual interface devices 16, 18. The first control system 14 can also be coupled to the first feedback device 20. In certain embodiments, other features, such as additional manual interface devices and/or feedback devices can also be present. Certain embodiments of the key fob 10 can comprise additional or fewer components and/or features, such as panic buttons, lights, and the like.

The first wireless transceiver 12 can be adapted to transmit and receive wireless signals in any of a variety of methods, such as infrared, radiofrequency (RF), or other portions of the electromagnetic spectrum, including the use of spread-spectrum technology. Certain embodiments of the transceivers as described throughout can comprise elements that are capable of receiving wireless signals as well as transmitting them. In some embodiments, a transceiver can be capable of only transmitting, while in others, it can only receive and, in still others, it can both transmit and receive wireless signals. In some embodiments, the first control system 14 can transmit and receive information through the first wireless transceiver 12. Such conveyance of information can conform to applicable standards, protocols, and constraints as practiced in the art.

The first control system 14 can be coupled to the other recited components of the key fob 10, allowing exchange of information to and from such components. Additionally, the first control system 14 can include or cooperate with a memory module, a power source, such as a battery or electrical supply from another module, and/or a microprocessor. Typically, such components are selected as suitable to enable the control system to interpret requests and commands from various components of the system 1 and respond, issue responses, and/or operate various components to produce the desired response, as suitable to operation in the system 1. Some non-limiting examples of such behavior can include initiation of transmissions using the first wireless transceiver 12 in response to manipulation of the first and/or second manual interface devices 16, 18, operation of the first feedback device 20 in response to the reception of a signal by the first wireless transceiver 12, and operation of the first feedback device 20 in response to manipulation of the manual interface devices 16, 18, or any combination thereof.

The first and second manual interface devices 16, 18 can comprise any of a number of mechanisms for permitted manual manipulation to cause input to the first control system 14. Such input can prompt, among other things, the first control system 14 to cause the first wireless transceiver 12 to transmit or broadcast a wireless signal. In some embodiments, such wireless signals can convey requests to a vehicle for, among other things, the unlocking of doors and/or hatches of a vehicle, unlatching of the trunk, and the like. Some types of devices suitable to serve as a manual interface device can include buttons, knobs, touch-sensitive graphic displays, and the like. In at least one embodiment, an elastomeric button, such as one constructed from rubber, silicone, or other flexible plastic, can be used.

Manipulation of a manual interface device or manual input device, such as the first and second manual interface devices 16, 18, can be performed in a variety of modes. Each interface device can comprise one or more separate mechanisms, such as buttons. In some modes, a single interface device can be pressed and held in an activated or engaged position for a specified period of time, such as at least a half second, a whole second, or multiple seconds. In others, both devices can be pressed substantially simultaneously. In certain modes, one interface device can be pressed and held in an activated position while the second interface device is pressed, then released. In some modes, the interface devices can be activated or engaged in a specific sequence, including alternating between the devices, either a single time or repetitiously, with different combinations of activations. Other modes can include manipulating one or more of the devices within a predetermined time interval of another, or manipulating one or more devices until a feedback device of the key fob is triggered. Other permutations and combinations of operational modes are also contemplated.

The first feedback device 20 can be a single mechanism or comprise a number of individual mechanisms, such as a visual feedback mechanism, an audible feedback mechanism, or a haptic feedback mechanism. The first feedback device 20 can be operated by the first control system 14 to produce or emit any of a variety of feedback modes. Some non-limiting examples of feedback modes can include a blinking light, an audible tone, a vibrating or buzzing sensation, a solid light, and intermittent beeping sound, a graphic or textual display, and any combination thereof, including patterns and sequences. Such feedback can convey responses to operations of the system or a status of one or more portions of the system, device, or vehicle, as appropriate to the circumstances and as operated by the first control system 14.

The vehicle 40 can comprise, among many other devices, mechanisms, and components, a second wireless transceiver 42, a second control system 44, and a third manual interface device 46. The vehicle 40 can be an automobile or other vehicle, such as a pick-up truck, sport utility vehicle, motorcycle, or watercraft. The illustrated elements of vehicle 40 can comprise individual components or they can be integrated with other components. As an example, the second wireless transceiver 42 can be integrally formed with a satellite radio antenna, though other combinations are possible. Similarly, the second control system 44 can be adapted to control various other portions of the vehicle 40, such as engine operations, audio entertainment control, fuel tracking and mileage estimation, among others. In some embodiments, the second control system 44 can be configured to perform a vehicular operation in response to receiving a wireless signal from the key fob 10.

The second control system 44 can also cooperate with other systems of the vehicle 40, such as the electrical system, a separate computing and data storage system, the HVAC system, a Global Positioning System, and so on. In at least one embodiment, the second control system 44 can be coupled to the second wireless transceiver 42, adapted to act as a wireless interface for other systems or components of the vehicle. As one non-limiting example, the second control system 44 and second wireless transceiver 42 can communicate information wirelessly between the vehicle's computing and/or data storage system and a remote wireless device such as 10. As another non-limiting example, the second wireless transceiver 42 can be adapted to receive a wireless signal conveying a request or command to unlock the vehicle's doors. In response, the second control system 44 can perform the operation. Such operations, also including activation or deactivation of a vehicle's theft prevention system, the operation of powered glass, such as opening or closing passenger windows, the unlatching and/or raising of a trunk, and the like can be considered vehicular operations, and many others are possible.

The second control system 44 can communicate wirelessly with other components of the system through cooperation with the second wireless transceiver 42, including participating in a wireless network with other wirelessly-communicating devices. As described in greater detail below, the vehicle 40 can interact with other wirelessly-communicating devices using the second wireless transceiver 42, including through an encrypted communications channel. As one non-limiting example, some components of the vehicle 40, such as a computing system, can communicate with remote computing systems using the second wireless transceiver 42 in cooperation with the second control system 44. In some embodiments, the second control system 44 can be integrally formed with such a computing system. The second control system 44 can additionally be coupled to the third manual interface device 46, similar to those described above.

The wireless access point 70 can comprise, among other components, a third wireless transceiver 72, a third control system 74, a fourth manual interface device 76, and a second feedback device 78. The wireless access point 70 can comprise the third wireless transceiver 72 coupled to the third control system 74, the fourth manual interface device 76, which can be similar to the first and second manual interface devices 16, 18, and the second feedback device 78, which can be similar to the first feedback device 20. The second feedback device 78 can be operable by the third control system 74. As with the first and second control systems 14, 44, the third control system 74 can comprise or be integrally formed with various other electronic components, such as a network adapter, an interface bus, various types of digital data storage, and the like. The third control system 74 can be adapted to communicate through the third wireless transceiver 72 in any suitable protocol and conforming to appropriate standards. In one non-limiting embodiment, the wireless access point 70 can interact with other wireless network devices, such as the second wireless transceiver 42 and vehicle 40 using IEEE standards, such as 802.11(b), 802.11(g), 802.11(n), among other standards. The wireless access point 70 can additionally communicate with other networkable computing systems, both wirelessly and, in certain embodiments, through a physical coupling, such as through a node or port complying to the Ethernet standard, IEEE 802.3.

In some embodiments, the wireless access point 70 can be adapted to communicate through an encrypted channel. Such encryption can be accomplished through any suitable scheme, including public key cryptography, the use of which is well-known in the art, as well as other methods, including the use of public key cryptography in a network security protocol, such as Wi-Fi Protected Access (WPA) and WPA2. Accordingly, the wireless access point 70 can comprise suitable components and/or configuration to encrypt and decrypt information wirelessly transmitted and received while participating in a wireless network.

To practice public key encryption, a system requires at least its own public and private keys—known as a key pair—as well as a public key that corresponds to an intended participant in the encrypted communication channel. Such keys can be generated and exchanged using a known system, such as the Diffie-Hellman key exchange protocol. Thus, the wireless access point 70 can store and retrieve for use its own key pair, as well as the public keys of other wireless devices between which communication is desired, such as the vehicle 40. Similarly, the vehicle 40 can store and retrieve its own key pair, as well as public keys of other devices, such as the wireless access point 70. When a vehicle first encounters a wireless access point, however, neither the vehicle nor the access point is likely to already have the other's public key, among other pieces of identifying information. Accordingly, it is advantageous to establish a method of key and information exchange that enables each wireless network participant to securely communicate with the other.

The exchange of public key and/or identifying information can be a first step in the eventual process of establishing secure communication between and among participants in a wireless network. Specifically, the exchange of such information, also known as security credentials, can be viewed as preparing for secure communications prior to the establishment of actual communication secured by the encryption, public-key or otherwise.

One method of exchanging public key and identifying information can be manual entry into each wireless device of the other's information, or a shared secure string of numbers or letters used to facilitate secure exchange. In some circumstances, such as where a vehicle is desired to be a wireless network participant, manual entry of a long alphanumeric string can be inconvenient and provide an obstacle to easy communication between the vehicle and other devices, such as the wireless access point.

Some devices can use the Wireless Protected Setup (WPS) standard to initiate contact and exchange information prior to participation in a secure wireless network. Other devices can use different wireless network security protocols, which can include those which exchange network security information through entry of such information into individual devices, or transmission of a shared secret prior to secure communication. In one practice of the WPS standard, a first device can transmit a WPS initiation signal, conveying a request to join a secure wireless network. A registrar of the secure wireless network can transmit a WPS response signal in response to reception of the WPS initiation signal. The content of the WPS initiation and WPS response signals can conform to the WPS standard and subsequent signals can be sent by either device to continue and/or complete the enrollment of the first device into the secure wireless network. The WPS initiation signal can convey information suitable to the WPS standard to initiate the enrollment process of the first device and the WPS response signal can conform to the WPS standard in responding to the initiation signal.

To remove the undesirable and inconvenient task of entering a long alphanumeric string, some embodiments of wireless devices can practice the WPS standard through a method known as Push Button Configuration (PBC). In PBC, a physical input, such as a button, is manipulated on both devices to initiate a WPS session and respond to a WPS initiation signal. Thus, in one embodiment, a user can press a button on a wireless device to transmit a WPS setup or initiation signal, and a wireless access point can receive the signal. A user can then manipulate a button or other input device on the wireless access point before a certain period of time has passed, in accordance with the WPS PBC specification, to transmit a valid response to the WPS initiation signal. Because of the physical interaction, timing requirements, and user attention, it is unlikely a wireless access point will be prompted to respond to unwanted WPS initiation requests. In the case where a vehicle is establishing a secure network connection with an access point, it can be inconvenient to press both buttons within the allotted time period, especially when one is coupled to the vehicle and the other is coupled to the wireless access point.

Thus, using the system 1, a user can manipulate at least one of the first and second manual input devices 16, 18 of the key fob 10 to transmit an activation signal 80 with the first wireless transceiver 12 of the key fob 10. Such manipulation can be any of the modes described above. The activation signal 80 can convey a request or command to the vehicle 40 indicating the user's desire to have the vehicle 40 transmit a WPS initiation signal 82. Thus, the vehicle 40 can transmit the WPS initiation signal 82 in response to receiving the activation signal 80 from the key fob 10.

In the depicted embodiment, the wireless access point 70 receives the WPS initiation signal 82. In response, the wireless access point 70 can perform or direct another component to perform one or more steps specified in the WPS standard for establishing secure communication with a mobile device, in this case, the vehicle 40. Additionally, the wireless access point 70 can operate its second feedback device 78 to inform a nearby user that the wireless access point 70 has received a WPS initiation signal 82.

A user can then manipulate the fourth manual interface device 76 of the wireless access point 70, indicating a request or command to proceed with the WPS procedure to establish secure communication with the device from which the WPS initiation signal 82 was received. In response, the wireless access point 70 can transmit a WPS response signal 84. The vehicle 40, after receiving the WPS response signal 84, can transmit another signal to the key fob 10 indicating the successful establishment of contact with the wireless access point 70. This signal, the acknowledgement signal 86, can be transmitted by the vehicle 40 and received by the key fob 10.

In response to the acknowledgement signal 86, the key fob 10 can operate the first feedback device 20. Accordingly, a user can be informed as to the success or failure of the activation 80 and/or WPS initiation 82 signals through different modes of operation of the first feedback device 20. Thus, a user can convey commands to the vehicle 40 remotely, removing the need for manual operation of one or more devices coupled to the vehicle 40 to establish the vehicle as a participant in a wireless network using WPS activation. Advantageously, a user within reach of the wireless access point 70 can use the key fob 10 to establish secure wireless communication between the wireless access point 70 and the vehicle 40. In some embodiments, the third manual interface device 46 of the vehicle 40 can additionally be used to perform some operations of the key fob 10, such as replacing the activation signal 80, allowing a user to begin the WPS procedure from within the vehicle 40, if desired.

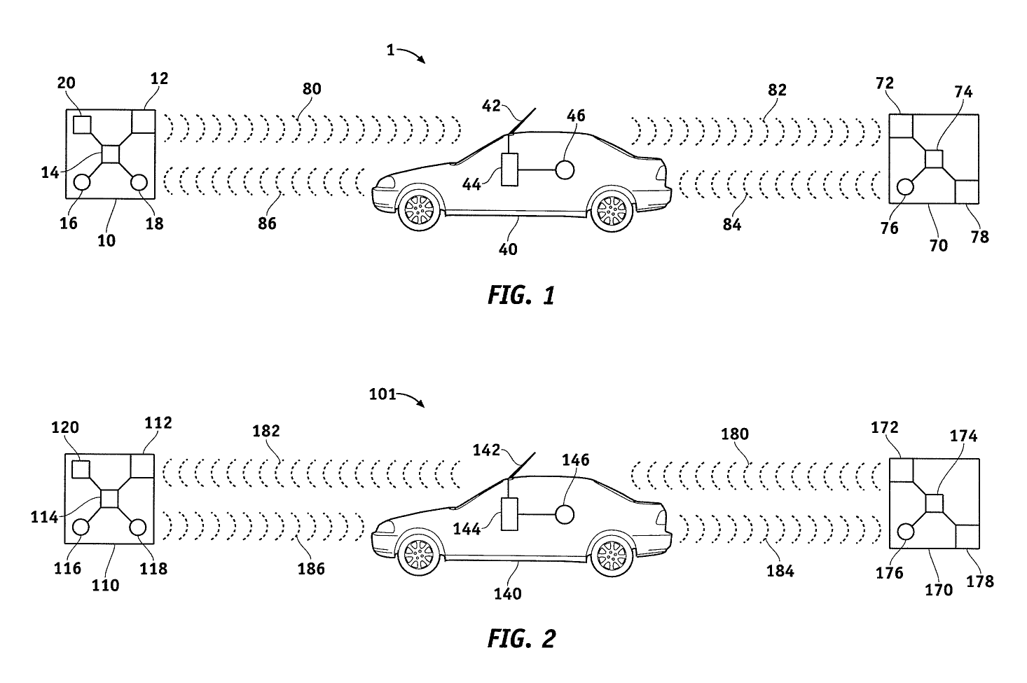

As illustrated in FIG. 2, in some embodiments, the wireless access point 170 can initiate the WPS procedure, transmitting a WPS initiation signal 180 which can be received by nearby wireless devices, such as the vehicle 140. Unless otherwise specified, components in FIG. 2 are similar to those in FIG. 1, except that the number designating the component has been incremented by 100. Under such circumstances, devices already participating in the secure wireless network with the wireless access point can ignore the signal, while a wireless device not already participating, such as the vehicle 140, can begin participating in the network after completing the WPS procedure.

Accordingly, a user can manipulate the fourth manual interface device 176 to cause the wireless access point 170 to transmit a WPS initiation signal 180. The vehicle 140 can receive the WPS initiation signal 180 and respond in a variety of ways. For example, in some embodiments, the vehicle 140 can operate a vehicular feedback mechanism (not shown), indicating it has received a WPS initiation signal. In certain embodiments, a user can manipulate the third manual interface device 146 of the vehicle 140 to transmit a WPS response signal 184, continuing the WPS procedure.

Additionally, in some embodiments, the vehicle 140 can transmit a WPS notification signal 182. The key fob 110 can operate the first feedback device 120 upon receiving the WPS notification signal 182, thereby notifying a nearby user of reception by the vehicle of a WPS initiation signal 180. The user can manipulate the first and/or second manual interface devices 116, 118 as described above to transmit an acknowledgement signal 186 from the key fob 110 to the vehicle 140. In response to the acknowledgment signal 186, the vehicle 140 can transmit a WPS response signal 184, thereby allowing a user to respond in at least two different ways to the reception of a WPS initiation signal 180 by the vehicle 140.

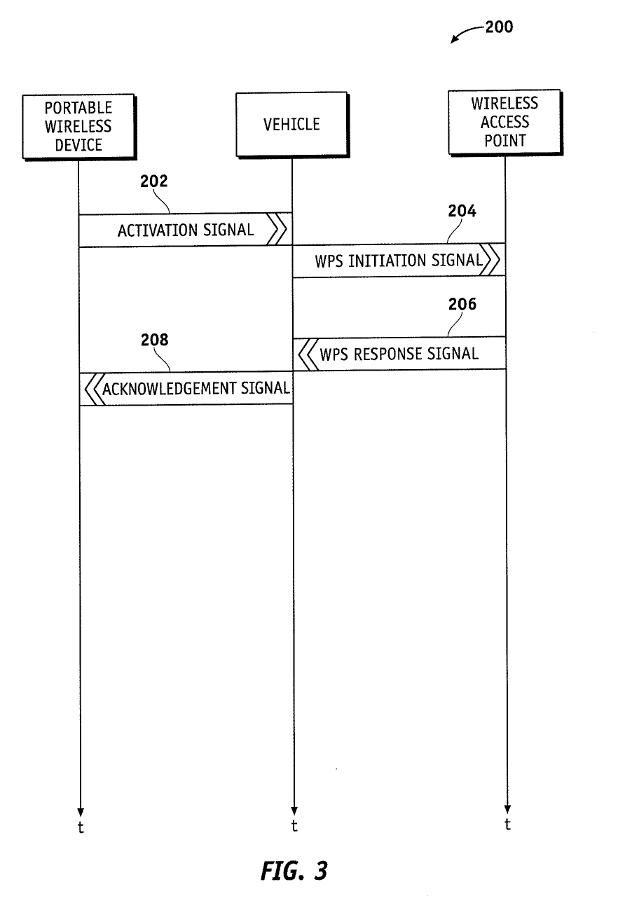

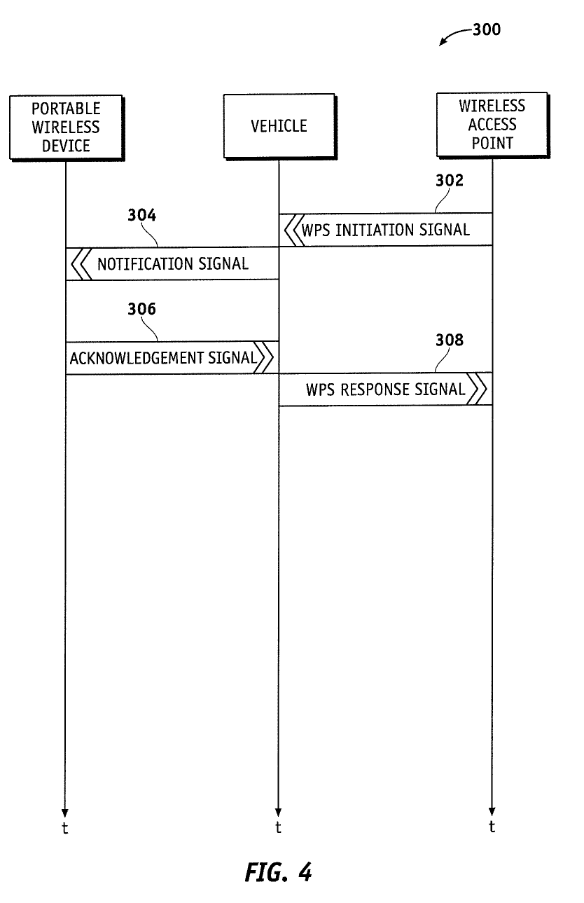

FIGS. 3 and 4 illustrate sequences 200, 300 of steps of a method of initializing secure wireless communication. The various tasks performed in connection with sequences 200, 300 may be performed by software, hardware, firmware, or any combination thereof. For illustrative purposes, the following description of sequences 200, 300 may refer to elements mentioned above in connection with FIGS. 1 and 2. In practice, portions of sequences 200, 300 may be performed by different elements of the described system, e.g., the first wireless transceiver 12, first control system 14, first manual interface device 16, second wireless transceiver 42, or second control system 44.

It should be appreciated that sequences 200, 300 may include any number of additional or alternative tasks, the tasks shown in FIGS. 3 and 4 need not be performed in the illustrated order, and sequences 200, 300 may be incorporated into a more comprehensive procedure or sequence having additional functionality not described in detail herein. Consequently, such additional steps, in sequences 200, 300 are not present in some embodiments, while other embodiments can comprise some or all of the illustrated steps as well as permutations and/or other steps described herein, though not illustrated.

In at least one embodiment, one sequence 200 of establishing secure communication between a vehicle and a wireless access point can comprise establishing an encrypted channel between them. As shown in FIGS. 3 and 4, signals can be exchanged between various sources and devices with increasing time t. Thus, signals occur in succession moving down the diagram. Direction of signal transmission direction is indicated by an arrow.

In the sequence illustrated in FIG. 3, a portable wireless device, such as a key fob, is used to initiate WPS between a vehicle and a wireless access point, thereby securing wireless communication between them. A user can manipulate the portable wireless device, which can be adapted to transmit an activation signal 202 in response to such manipulation. Other manipulations, such as pressing different buttons or the same button in a different pattern, or in conjunction with others, can cause the vehicle to perform a vehicular action, as described above. As shown, the vehicle can receive the activation signal 202 and transmit a WPS initiation signal 204 in response. The wireless access point can receive the WPS initiation signal 204. In some embodiments, the wireless access point can transmit a WPS response signal 206 in response to reception of the WPS initiation signal 204. In certain embodiments, the wireless activation point can comprise a feedback device which activates in response to receiving the WPS initiation signal 204. In some embodiments, the wireless access point can be configured to transmit the WPS response signal 206 only when a manual interface device of the access point is manipulated within a certain, predetermined time interval after reception of the WPS initiation signal 204.

The vehicle can receive the WPS response signal 206 and transmit the acknowledgment signal 208 in response. The portable wireless device, in response to receiving the acknowledgement signal 208, can operate a feedback device as a means of user confirmation. In certain embodiments, further WPS steps can occur between the vehicle and the access point with or without further intervention from a user via the portable wireless device or through manipulation of a portion of the vehicle.

In some embodiments, the WPS session can be initiated by the wireless access point, as shown in the sequence 300 illustrated in FIG. 4. Thus, the wireless access point can transmit a WPS initiation signal 302 in response to manipulation of a button or other portion of the wireless access point. The vehicle can transmit a notification signal 304 to the portable wireless device in response to receiving the WPS initiation signal 302. In response to receiving the notification signal, 304, the portable wireless device can operate a feedback device as a means of notifying the user. A user can manipulate the portable wireless device, resulting in transmission of an acknowledgement signal 306 to the vehicle. In response to receiving the acknowledgement signal 306, the vehicle can transmit a WPS response signal 308 to the wireless access point, furthering the WPS session. In some embodiments, the WPS sequence can have a window of opportunity for transmission of a WPS response signal, and a prolonged delay can result in termination of the session. Thus, in certain embodiments, the acknowledgment signal 306 must be received by the vehicle within a predetermined time or the WPS response signal 308 can be omitted. In such situations and embodiments, the portable wireless device can additionally operate a feedback device indicating the unsuccessful termination of the WPS session. In certain embodiments, a user can manipulate a portion of the vehicle to initiate the WPS response signal 308, rather than transmitting the acknowledgment signal 306 from the portable wireless device. In some embodiments of either sequence 200, 300 or any embodiment, a further signal (not shown) can be transmitted from the vehicle to the portable wireless device indicating successful completion of the WPS session. The portable wireless device can operate a feedback device or element in response to receiving such a signal.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A wireless communication system comprising:
a portable wireless device comprising a first manual interface device, the portable wireless device adapted to transmit an activation signal in response to manipulation of the first manual interface device; and
an onboard wireless communication device for a vehicle, the onboard wireless communication device adapted to transmit Wi-Fi Protected Setup (WPS) initiation signals in response to receiving the activation signal.

2. The wireless communication system of claim 1, wherein the onboard wireless communication device further comprises a second manual interface device, and wherein the onboard wireless communication device is adapted to transmit WPS initiation signals in response to manipulation of the second manual input device.

3. The wireless communication system of claim 1, wherein the onboard wireless communication device is further adapted to transmit a notification signal in response to receiving a remotely-originating WPS initiation signal.

4. The wireless communication system of claim 3, wherein the portable wireless device further comprises a third manual interface device, and the portable wireless device is further adapted to transmit an acknowledgment signal in response to manipulation of at least one of the first and third manual interface devices.

5. The wireless communication system of claim 4, wherein the onboard wireless communication device is adapted to transmit a WPS response signal in response to receiving the acknowledgment signal.

6. The wireless communication system of claim 5, wherein the portable wireless device further comprises a feedback device, and the portable wireless device is further adapted to operate the feedback device in response to reception of at least one of the WPS notification signal and the acknowledgment signal.

7. The wireless communication system of claim 1, further comprising a wireless access point comprising a fourth manual interface device, and the wireless access point is further adapted to transmit a WPS response signal in response to manipulation of the fourth manual interface device.

8. The wireless communication system of claim 1, further comprising a wireless access point comprising a fourth manual interface device, the wireless access point is adapted to transmit the WPS response signal in response to reception of the WPS initiation signal.

9. The wireless communication system of claim 7, wherein the wireless access point is further adapted to transmit WPS initiation signals in response to manipulation of the fourth manual interface device.

10. A method of preparing secure communication between a vehicle and a wireless access point comprising:
receiving a wireless activation signal from a key fob associated with the vehicle; and
transmitting a Wi-Fi Protected Setup (WPS) initiation signal from the vehicle in response to reception by the vehicle of the wireless activation signal.

11. The method of claim 10, further comprising:
receiving the WPS initiation signal at a wireless access point; and
transmitting a WPS response signal from the wireless access point in response to receiving the WPS initiation signal.

12. The method of claim 10, further comprising transmitting the wireless activation signal from the key fob, wherein transmitting the wireless activation signal is responsive to manipulation of at least one button of the key fob.

13. The method of claim 12, wherein manipulation of at least one button of the key fob comprises activation of each of at least two buttons at different times.

14. The method of claim 12, wherein manipulation of at least one button of the key fob comprises activation of at least one of the buttons for at least one second.

15. The method of claim 12, wherein the key fob is adapted to transmit a signal requesting a vehicular action in response to a user pressing the at least one button.

16. A method of preparing secure communication between a vehicle and a wireless access point comprising:
receiving a wireless network security protocol initiation signal at the vehicle;
transmitting a notification signal from the vehicle in response to receiving the wireless network security protocol initiation signal;
receiving the notification signal at a key fob;
operating a feedback device of the key fob in response to the notification signal;
transmitting an acknowledgement signal from the key fob in response to manipulation of a manual interface device of the key fob;
receiving the acknowledgement signal at the vehicle; and
transmitting a wireless network security protocol response signal from the vehicle in response to receiving the acknowledgment signal.

17. The method of claim 16, wherein operating a feedback device comprises emitting an audible or visual signal from the key fob.

18. The method of claim 16, wherein manipulation of the manual interface device of the key fob comprises activation of at least one button of the key fob.

19. The method of claim 18, wherein manipulation of the manual interface device comprises engagement and release of at least one button of the key fob concurrently with engagement of a second button of the key fob.

20. The method of claim 16, further comprising transmitting the wireless network security protocol initiation signal from a wireless access point.
